(19) United States
(12) Patent Application Publication
(10) Pub. No.: US 2021/0209222 A1
(43) Pub. Date: Jul. 8, 2021

(54) SECURITY DEVICE AND METHOD FOR PROVIDING SECURITY SERVICE THROUGH CONTROL OF FILE INPUT/OUTPUT AND INTEGRITY OF GUEST OPERATING SYSTEM

(71) Applicant: Soosan INT Co., Ltd., Seoul (KR)

(72) Inventors: Hoi Chan JEONG, Seoul (KR); Ji Hoon MOON, Seoul (KR); Jun Yeong PARK, Seoul (KR)

(73) Assignee: Soosan INT Co., Ltd., Seoul (KR)

(21) Appl. No.: 17/058,705

(22) PCT Filed: Mar. 21, 2019
(86) PCT No.: PCT/KR2019/003273

§ 371 Date: Nov. 25, 2020

(30) Foreign Application Priority Data
May 25, 2018 (KR) 10-2018-0059809

(51) Int. Cl. G06F 21/52

(52) U.S. Cl. CPC G06F 21/52; G06F 2221/033

(57) ABSTRACT

If a request to execute an executable file of a guest operating system or an executable file being executed in the guest operating system is detected, the present disclosure calculates a hash value before the executable file is executed and compares the calculated hash value with a pre-stored hash value, thereby securing security of the executable file; parses a file system of the guest operating system prior to starting the guest operating system and verifies integrity of a virtualization driver, and if the virtualization driver has integrity according to a result of the verification, blocks modulation of a memory area where the virtualization driver is allocated, a memory area corresponding to a master boot record (MBR) of the guest operating system, and a memory area corresponding to a volume boot record (VBR) of the guest operating system, and if an access to a file occurs in the virtualization driver, determines authority to access the file to which the access was requested, and processes the access accordingly, and thus protects the file.

### 1. FIELD

Embodiments disclosed hereinbelow relate to a security device and method for securing integrity of a guest operating system in operating the guest operating system in a virtualization system, and for controlling file input/output when accessing the file through the guest operating system.

### 2. BACKGROUND

The dictionary meaning of “virtualization” is defined as “to assume and treat something that does not actually exist or is ambiguous as a fact or entity that actually exists”.

In the present disclosure, the virtualization technology is “a technology that can install and use a computer operating system without being affected by the system structure or hardware”.

Virtualization technology was first proposed by IBM in the 1970s. At that time, it was proposed in order to solve the problems of space saving and cost of the main frame. In recent years, however, virtualization technology has been gathering attention not only for its cost reduction effect, but also for providing compatibility, flexibility, and security. Main application fields include various areas such as server virtualization for cloud computing, desktop virtualization, and mobile virtualization, etc.

The reason why such virtualization technology is used for security is based on high isolation, which is one of the advantages of virtualization. A virtualization environment generally consists of a virtual machine on which a guest operating system runs and a virtual machine monitor (VMM) or hypervisor on which a host operating system runs to manage the virtual machine, and each virtual machine is present as an isolated space. In particular, even if a threat occurs on the virtual machine, it does not affect other virtual machines or virtual machine monitors except for the corresponding virtual machine.

However, in virtualization systems, the security solutions used in existing physical machines are showing limitations, and the frequency of security threats is increasing significantly.

The representative reason why the security solutions show limitations in virtualization systems is because multiple operating systems can be installed in one virtualization system.

If hackers access data by attacking at the operating system level using one of the operating systems installed in the virtualization system, it is difficult to be blocked.

Therefore, a technology that can efficiently monitor and block access to data is required.

### SUMMARY

The present disclosure was derived to solve the problems of prior art as described above, and the present disclosure is able to calculate and store in advance a hash value in executable files related to a guest operating system and all executable files being executed under the guest operating system, calculate a hash value before an executable file is executed, and then compare it with the prestored hash values, thereby confirming the integrity of the executable file to be executed.

In addition, a purpose of the present disclosure is to provide a method for parsing a file system of a guest operating system before starting the guest operating system and verifying integrity of a virtualization driver, and if the virtualization driver has integrity according to a result of the verification, blocking modulation of a memory area where the virtualization driver is allocated, a memory area corresponding to a master boot record (MBR) of the guest operating system and a memory area corresponding to a volume boot record (VBR) of the guest operating system, and if an access occurs in the virtualization driver to the file, determining whether there is authority to access the file to which the access was requested, and processing the access accordingly, thereby protecting the file.

In order to achieve the aforementioned purpose, a method for providing a security service in a security device according to an embodiment of the present disclosure includes detecting an execution request for an executable file of a guest OS or an executable file being executed in the guest OS; if the execution request the executable file is detected, searching a hash table for a hash value corresponding to the executable file; if the hash value corresponding to the executable file is present in the hash table, calculating a hash value of the executable file; comparing the found hash value and the calculated hash value; and if the found hash value and the calculated hash value are the same according to a result of the comparing, allowing to execute the executable file.

Here, the method may further include, prior to the detecting of an execution request for an executable file, if requested to install the executable file, identifying whether the installation request is requested through a pre-allowed local network; and if the installation request is requested through the pre-allowed local network according to a result of the identifying, calculating the hash value of the executable file using a predetermined hash function, and storing the calculated hash value in the hash table as the hash value corresponding to the executable file.

Here, the method for providing a security service in a security device may further include, if requested to update the executable file, identifying whether the update request is requested through a pre-allowed local network; and if the update request is requested through the pre-allowed local network according to a result of the identifying, calculating the hash value of the updated executable file using the predetermined hash function, and storing the hash value of the updated executable file in the hash table as the hash value corresponding to the executable file.

Here, the method for providing a security service in a security device may further include, if the hash value corresponding to the executable file is not present in the hash table or the found hash value and the calculated hash value are not the same according to a result of the comparing of the found hash value and the calculated hash value, blocking execution of the executable file.

Here, the hash table may store the hash value corresponding to a pre-installed executable file.

Here, the hash table may store the hash value corresponding to a pre-installed executable file, and may further include at least one of identifier information for identifying the executable file or a path of the executable file.

A method for providing a security service in a security device according to another embodiment of the present disclosure may include parsing a file system of a guest operating system prior to starting the guest operating system and verifying integrity of a virtualization driver that executes the guest operating system; if the virtualization driver has integrity according to a result of the verification, blocking modulation of a memory area to which the virtualization driver is allocated, a memory area corresponding to a master boot record (MBR) of the guest operating system, and a memory area corresponding to a volume boot record (VBR) of the guest operating system; executing the guest operating system and the virtualization driver; if an access to a file occurs in the virtualization driver, transmitting access information of the file to which the access occurred to a host operating system file protector and inquiring whether the access is possible; determining authority to access the file through a protection policy manager in the host operating system file protector; and transmitting a result of the determination regarding the access to the file to the virtualization driver.

Here, the method for providing a security service in a security device may further include, if the result of the determination regarding the file received in the virtualization driver is deny the access, blocking the access to the file, and if the result of determination regarding the file received is allow the access, performing the requested access to the file.

Here, the blocking of modulation of the memory area, if the host operating system file protector receives a starting time of the virtualization driver and an address of the memory area to be modulation-blocked from the virtualization driver, may block modulation by setting the authority to access the memory area to which the virtualization driver is allocated, the memory area corresponding to the master boot record (MBR) of the guest operating system, and the memory area corresponding to the volume boot record (VBR) of the guest operating system to read only.

Here, the determining of authority to access the file may identify and determine access authority of access information of the file from a list of files predetermined as subject for protection stored in the protection policy manager, the access information of the file may include a path of the file, information of a process for accessing the file, and a requested access type, and the list of files may include the path of the file and authority to access the file of an accessible process, or the path of the file and authority to access the file of a file modifying process.

Here, the determining of authority to access the file may identify and determine access authority regarding access information of the file from a list of files predetermined as subject for protection stored in the protection policy manager, the access information of the file may include an extension of the file, information of a process for accessing the file and a requested access type, and the list of files may include information of an accessible process corresponding to each extension, authority to access a corresponding extension of the accessible process, or information of a file modifying process corresponding to each extension, authority to access the corresponding extension of the file modifying process.

A security device that provides a security service according to an embodiment of the present disclosure includes a hash value manager that, if a hash value corresponding to an executable file is present in a hash table, calculates a hash value of the executable file, and compares the hash value found from the hash table and the calculated hash value, and if the found hash value and the calculated hash value are the same, determines to allow executing the executable file; and a host operating system file protector that, if an execution request for an executable file of a guest operating system or an executable file being executed in the guest operating system is detected, identifies whether the execution is possible through the hash value manager, and allows executing the executable file according to a result of determination.

Here, if an installation request for the executable file is received prior to detecting an execution request for the executable file, the hash value manager may identify whether the installation request is requested through a pre-allowed local network by a predetermined local terminal, and if the installation request is requested through the pre-allowed local network by the predetermined local terminal, the hash value manager may calculate the hash value of the executable file using a predetermined hash function, and store the calculated hash value in the hash table as the hash value corresponding to the executable file.

Here, if a update request for the executable file is received, the hash value manager may identify whether the update request is requested through a pre-allowed local network by the predetermined local terminal, and if the update request is requested through the pre-allowed local network by the predetermined local terminal, the hash value manager may calculate a hash value of the updated executable file using the predetermined hash function, and store the hash value of the updated executable file in the hash table as the hash value corresponding to the executable file.

Here, if the hash value corresponding to the executable file is not present in the hash table, or the found hash value and the calculated hash value are not the same according to a result of comparing the found hash value and the calculated hash value, the hash value manager may determine to not allow executing the executable file.

Here, the security device that provides a security service may include a parser that parses a file system of the guest operating system prior to starting the guest operating system and verifies integrity of a virtualization driver for executing the guest operating system; a protection policy manager that determines authority to access a file according to access information of the file; and the virtualization driver that, if an access to the file occurs, transmits the access information of the file to which the access occurred to the host operating system file protector and inquires whether the access is possible, wherein the host operating system file protector, if the virtualization driver has integrity according to a result of verification, blocks modulation of a memory area where the virtualization driver is allocated, a memory area corresponding to a master boot record (MBR) of the guest operating system, and a memory area corresponding to a volume boot record (VBR) of the guest operating system, and if the access information of the file is received from the virtualization driver, transmits a result of determining the authority to access the file according to the access information of the file through the protection policy manager to the virtualization driver.

Here, if the result of determination regarding the file received in the virtualization driver is deny the access, the virtualization driver may block the access to the file, and if the result of determination is allow the access, the virtualization driver may perform the access to the file.

Here, if a starting time of the virtualization driver and an address of the memory area to be modulation-blocked are received from the virtualization driver, the host operating system file protector may block the modulation by setting the authority to access the memory area to which the virtualization driver is allocated, the memory area corresponding to the master boot record (MBR) of the guest operating system, and the memory area corresponding to the volume boot record (VBR) of the guest operating system to read only.

Here, the protection policy manager may identify and determine the access authority regarding the access information of the file from a list of files predetermined as subject for protection stored in the protection policy manager, the access information of the file may include a path of the file, information of a process for accessing the file, and a requested access type, and the list of files may include the path of the file and authority to access the file of the accessible process, or the path of the file and authority to access the file of a file modifying process.

Here, the protection policy manager may identify and determine the access authority of the access information of the file from a list of files predetermined as subject for protection stored in the protection policy manager, the access information of the file may include an extension of the file, information of a process for accessing the file, and a requested access type, and the list of files may include information of the accessible process corresponding to each extension, authority to access the corresponding extension of the accessible process, or information of a file modifying process corresponding to each extension, authority to access the corresponding extension of the file modifying process.

If an execution request for an executable file of a guest operating system or an executable file being executed in the guest operating system is detected, the present disclosure may calculate a hash value before the executable file is executed and compare the same with a prestored hash value, so as to confirm the integrity of the executable file to be executed, and also, by parsing a file system of the guest operating system before starting the guest operating system and verifying the integrity of a virtualization driver, and if the virtualization driver has integrity according to a result of the verification, by blocking modulation of a memory area where the virtualization driver is allocated, a memory area corresponding to a master boot record (MBR) of the guest operating system and a memory area corresponding to a volume boot record (VBR) of the operating system, and if an access occurs from the virtualization driver to a file, by determining whether there is authority to access the file to which the access is requested, and by processing the access accordingly, the present disclosure may protect the file.

### BRIEF DESCRIPTION OF THE DRAWINGS

FIG. 1 is a view illustrating a configuration of a security device that secures resources of a guest operating system and a file system in a virtualization system according to an embodiment;

FIG. 2 is a view illustrating a page table entry for modifying in order to block modulation of a memory area of a virtualization driver according to an embodiment;

FIG. 3 is a flowchart illustrating a process for inspecting an executable file before execution in a security device according to an embodiment;

FIG. 4 is a flowchart illustrating a process for installing an executable file in a security device according to an embodiment;

FIG. 5 is a flowchart illustrating a process for updating an executable file in a security device according to an embodiment;

FIG. 6 is a flowchart illustrating a process for protecting a file in a security device according to an embodiment;

FIG. 7 is a flowchart illustrating a process for processing an access to a file depending on the authority to access the file in a security device according to an embodiment; and

FIG. 8 is a view illustrating a message flow for protecting a file in a security device according to an embodiment.

### DETAILED DESCRIPTION

Hereinbelow, embodiments will be described in detail with reference to the drawings attached. However, various modifications can be made to the embodiments, and thus the scope of rights of the patent application is not limited or restricted by those embodiments. It should be understood that all changes, equivalents, or substitutes to the embodiments are included in the scope of rights.

Terms used in the embodiments are used for illustrative purposes only and should not be construed as limiting. Singular expressions include plural expressions unless the context clearly indicates otherwise. It should be understood that, in the present specification, the terms “comprises/includes” or “have/has” intend to designate the presence of the mentioned characteristic, number, step, operation, element, component or a combination thereof, and not to exclude the possibility of presence or addition of one or more other characteristic, number, step, operation, element, component or a combination thereof.

Unless defined otherwise, all the terms used in the present specification including technical or scientific terms have the same meaning as would be commonly understood by those in the art which the embodiments pertain to. Further, terms such as those defined in generally used dictionaries should be construed as having a meaning consistent with the meaning in the context of the related art, and unless defined clearly in the present specification, should not be construed ideally or overly.

Further, in describing the present disclosure with reference to the drawings attached, regardless of the reference numerals, like reference numerals indicate like components, and redundant descriptions thereof will be omitted. In describing the embodiments, when it is determined that a detailed description of a related known technology may unnecessarily obscure the subject matter of the embodiment, a detailed description thereof will be omitted.

Hereinbelow, embodiments will be described in detail with reference to the drawings attached. However, the scope of the patent application is not limited or restricted by those embodiments. Like reference numerals presented in each drawing indicate like components.

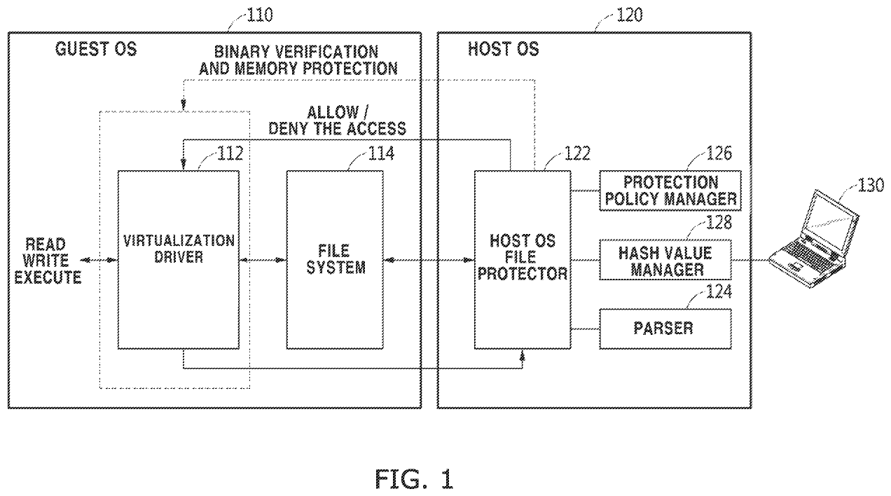

Hereinbelow, a security device and method for providing a security service through integrity of a guest operating system and file input/output control according to an embodiment of the present disclosure will be described in detail with reference to FIGS. 1 to 8.

FIG. 1 is a view illustrating a configuration of a security device that secures resources of a guest operating system and a file system in a virtualization system according to an embodiment of the present disclosure.

Referring to FIG. 1, the security device may be configured to largely include a guest operating system (OS) 110, a host operating system (OS) 120, and a local terminal 130.

The guest OS 110 has an IP address and may be connected to a network, whereas the host OS 120 does not have an IP address. The host OS 120 can only be controlled through a local terminal 130 through a local network, and data being transmitted to the guest OS 110 through the network is delivered to the guest OS 110 through the host OS 120, but since the host OS 120 does not have an IP address, the host OS 120 cannot be accessed directly from the outside.

More specifically, the guest OS 110 may be configured to include a para-virtualized agent 112 and a file system 114, while the host OS 120 may be configured to include a host OS file protector 122, a parser 124, a protection policy manager 126, and a hash value manager 128.

If an execution request for an executable file of the guest OS or an executable file being executed in the guest OS is received, the hash value manager 128 identifies whether it is an installation request that is through a local network pre-allowed by a predetermined local terminal 130, and if so, the hash value manager 128 calculates a hash value of the executable file using a predetermined hash function, and stores the calculated hash value in a hash table as the hash value corresponding to the executable file.

Here, the hash value of the executable file may be calculated by inputting file contents of the executable file as an input value of the predetermined hash function.

In addition, the executable file is a file corresponding to an executable file structure. For example, a file with extension such as EXE, DLL, SYS and the like may be the executable file.

Here, the hash table may store the hash value corresponding to a pre-installed executable file. If there are multiple hash values stored in the hash table, the hash table may store the hash values corresponding to the pre-installed executable files, and may further include at least one of identifier information for identifying the executable file or a path of the executable file.

If a update request for the executable file of the guest OS or the executable file being executed in the guest OS is received, the hash value manager 128 identifies whether it is an update request through a local network pre-allowed by the predetermined local terminal 130, and if so, the hash value manager 128 calculates a hash value of the updated executable file using the predetermined hash function, and stores the calculated hash value of the updated executable file in the hash table as the hash value corresponding to the executable file.

If the hash value corresponding to the executable file is present in the hash table, the hash value manager 128 calculates the hash value of the executable file, and compares the hash value found from the hash table with the calculated hash value, and if the found hash value and the calculated hash value are the same, the hash value manager 128 determines to allow executing the executable file.

Meanwhile, if the hash value corresponding to the executable file is not present in the hash table or the found hash value and the calculated hash value are not the same according to a result of comparing the found hash value and the calculated hash value, the hash value manager 128 determines not to allow executing the executable file.

If an execution request for the executable file of the guest OS or the executable file being executed in the guest OS is received, the host OS file protector 122 determines, through the hash value manager 128, whether executing the executable file is possible, and allows executing the executable file according to a result of determination.

Prior to starting in the guest OS system, the virtualization driver 112 provides the starting time and memory area information of the virtualization driver to the parser 124 through the host OS file protector 122 to identify whether it has integrity. Here, the memory address that corresponds to the memory area information of an agent may be obtained through kernel structure and Application Programming Interface (API).

The virtualization driver 112 may be implemented regardless of the operating system, but the implementation method may vary depending on the operating system. For example, in the case of Windows, the virtualization driver 112 may be implemented through a file system minifilter driver, and in the case of Linux, the virtualization driver 112 may be implemented through a kernel module.

Prior to starting the guest OS 110, the parser 124 parses a file system of the guest OS, verifies integrity of the virtualization driver, and provides the verification result to the host OS file protector 122.

If the virtualization driver has integrity according to the verification by the parser 124, the host OS file protector 122 blocks modulation of the memory area to which the virtualization driver 112 is allocated.

In addition, the host OS file protector 122 blocks modulation of the memory area that corresponds to the master boot record (MBR) of the guest OS and the memory area that corresponds to the volume boot record (VBR) of the guest OS.

More specifically, the host OS file protector 122 may block modulation by setting the authority to access the memory area to which the virtualization driver 112 is allocated to read only using the received starting time of the virtualization driver 112 and the address of the memory area to which the virtualization driver 112 is allocated.

In addition, it is possible to block modulation by setting the authority to access the corresponding memory area to read only using the address of the memory area corresponding to the master boot record (MBR) of the guest OS and the address of the memory area corresponding to the volume boot record (VBR) of the guest OS.

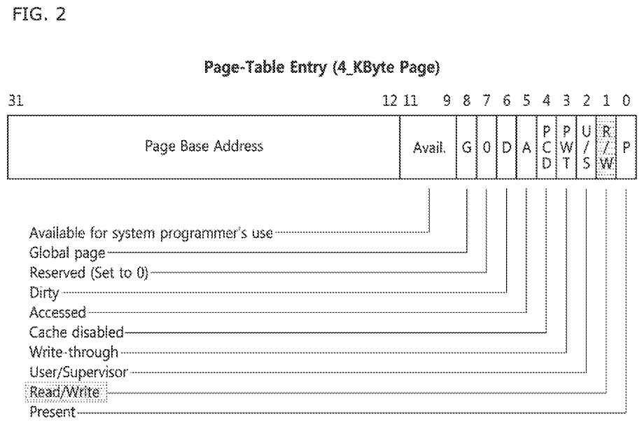

FIG. 2 is a view illustrating a page table entry for modification in order to block modulation of the memory area of the virtualization driver according to an embodiment.

Referring to FIG. 2, the host OS file protector 122 may block modulation by modifying the access authority (RWX bits) displayed with shades in the page table entry into ‘read’ that corresponds to ‘do not write’.

Meanwhile, in order to block modulation of the memory area, in the case of Intel, Extended Page Table (EPT), which is a memory virtualization technology, may be utilized, and in the case of AMD, Nested Page Tables (NPT) may be utilized.

If an access to a file occurs, the virtualization driver 112 may transmit access information of the file where the access occurred to the OS file protector 122, and inquire whether the access is possible. Here, the access information of the file may include a full path name of the file, information of a process for accessing the file, and a requested accesstype (for example, read, write, execute, etc.).

If the access information of the file is received from the virtualization driver 112, the host OS file protector 122 may request to determine the access authority of the file corresponding to the access information of the file through the protection policy manager 126, and if the determination result is received from the protection policy manager 126, transmit the determination result to the virtualization driver 112.

The protection policy manager 126 may determine whether accessing the file is possible by identifying the authority to access the access information of the file from a list of files predetermined as subject for protection. Here, the list of files may include the path of the file and the authority to access the file of the accessible process, or the path of the file and the authority to access the file of the file modifying process.

Meanwhile, in a case where the access information of the file includes an extension of the file, information of the process for accessing the file, and the requested access type, the list of files may include information of the accessible process corresponding to each extension, the access authority of the accessible process to the corresponding extension, or information of the file modifying process corresponding to each extension, the access authority of the file modifying process to the corresponding extension.

Here, the access authority of the accessible process to the file may be set to ‘read’, so that modulation of the file is not possible. In addition, the access authority of the file modifying process to the file may be set to at least one of ‘read’, ‘write’, and ‘execute’, so that only a preset file modifying process can modify the file.

The virtualization driver 112 may receive the result of determining whether accessing the file is possible from the host OS file protector 122, and if the result of determination regarding the file is deny the access ‘deny’, the virtualization driver 112 may block the access to the file, and if the result of determination regarding the file is allow the access ‘allow’, the virtualization driver 112 may enable the requested access to the file.

Meanwhile, the virtualization driver 112 and the host OS file protector 122 may communicate using a hypercall interface.

Hereinbelow, a method of the present disclosure configured as above will be described hereinbelow with reference to the drawings.

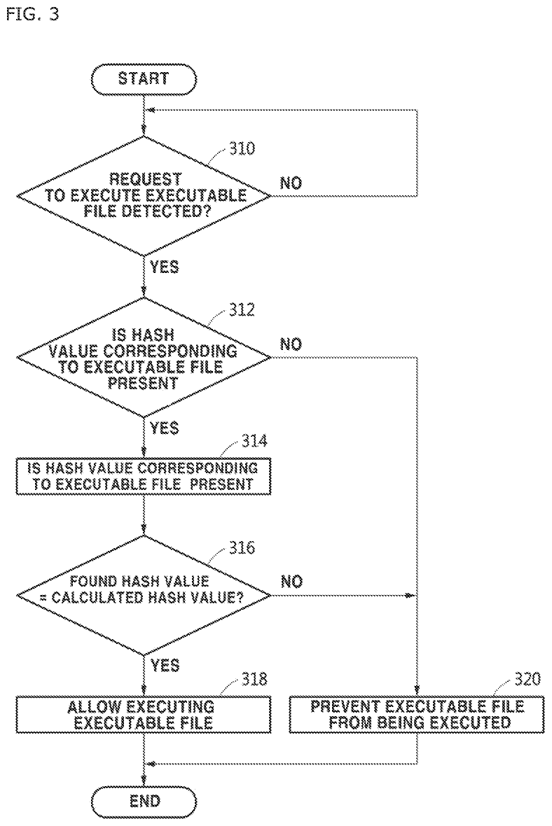

FIG. 3 is a flowchart illustrating a process for inspecting an executable file prior to execution in a security device according to an embodiment.

Referring to FIG. 3, if an execution request for an executable file of the guest OS or an executable file being executed in the guest OS is detected (S310), the security device searches for a hash value corresponding to the executable file in the hash table (S312).

Here, the hash table may store the hash value corresponding to a pre-installed executable file. If there are multiple hash values stored in the hash table, the hash table may store the hash values corresponding to the pre-installed executable files, and may further include at least one of identifier information for identifying the executable file or a path of the executable file.

If the hash value corresponding to the executable file is present in the hash table according to a result of the search at step S312, the security device calculates a hash value of the executable file (S314).

In addition, the security device compares the found hash value and the calculated hash value (S316).

If the found hash value and the calculated hash value are the same according to a result of the comparison at step 316, the security device allows executing the executable file (S318).

If the hash value that corresponds to the executable file is not present in the hash table as a result of the searching at step 312, or the found hash value and the calculated hash value are not the same as a result of the comparison at step 316, the security device prevents the executable file from being executed (S320).

Meanwhile, in order to compare the hash value according to the execution request for the executable file in FIG. 3, the security device must pre-store the hash value when installing the executable file.

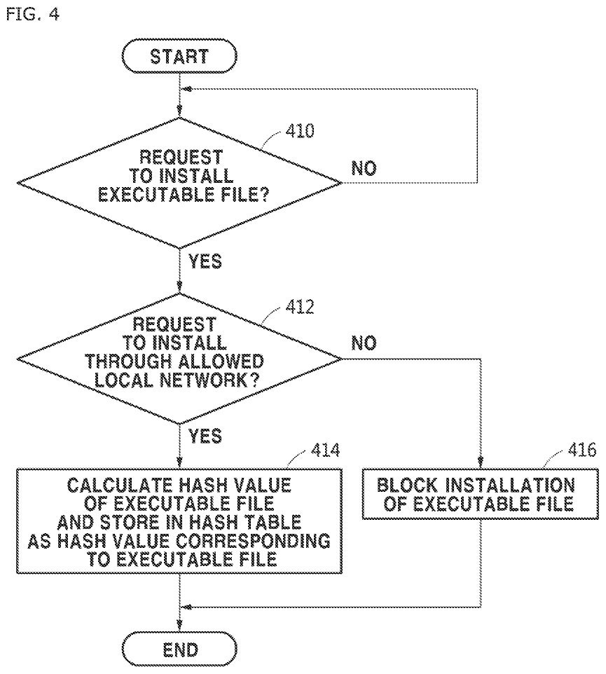

FIG. 4 is a flowchart illustrating a process for installing an executable file in a security device according to an embodiment.

Referring to FIG. 4, if an installation request for an executable file is received (S410), the security device identifies whether it is an installation request received from a predetermined local terminal through a pre-allowed local network (S412).

If the installation request is requested through a pre-allowed local network according to the result of the identifying at step 412, the security device calculates a hash value of the executable file using a predetermined hash function and stores the same in the hash table as the hash value corresponding to the executable file (S414).

If the installation request is not requested through a pre-allowed local network according to a result of the identifying at step 412, the security device blocks installing the executable file (S416).

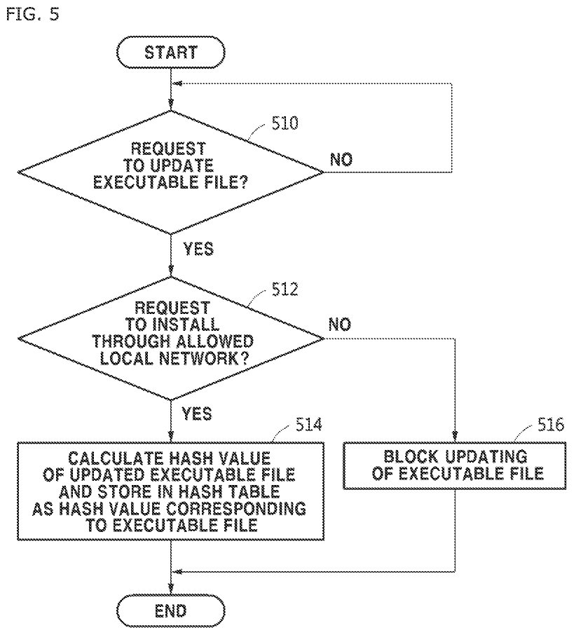

FIG. 5 is a flowchart illustrating a process for updating an executable file in a security device according to an embodiment.

Referring to FIG. 5, if a update request for an executable file is received (S510), the security device identifies whether it is an update request received from the predetermined local terminal through the pre-allowed local network (S512).

If the update request is requested through the pre-allowed local network according to a result of the identifying at step 512, the security device calculates a hash value of the updated executable file using the predetermined hash function, and stores and updates the calculated hash value in the hash table as the hash value corresponding to the executable file (S514).

If the update request is not requested through a pre-allowed local network according to a result of the identifying at step 512, the security device blocks updating the executable file (S516).

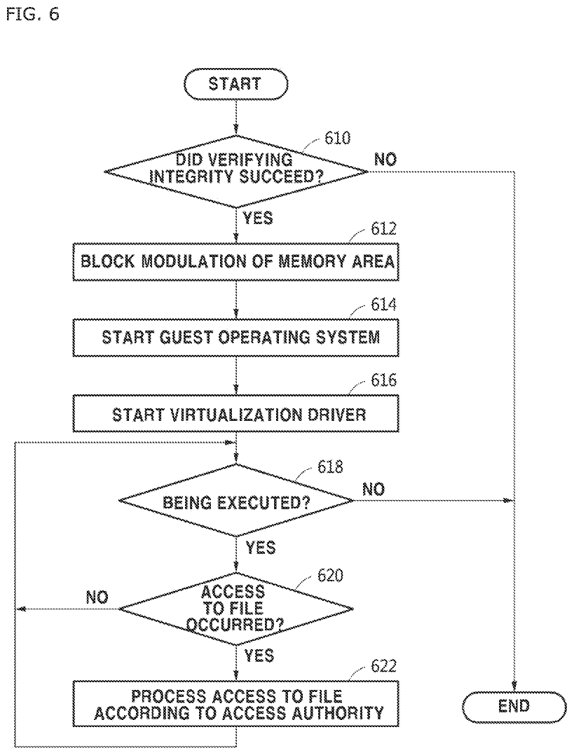

FIG. 6 is a flowchart illustrating a process for protecting a file in a security device according to an embodiment.

Referring to FIG. 6, prior to starting the guest OS, the parser parses the file system of the guest OS and verifies integrity of the virtualization driver (S610).

If the virtualization driver has integrity according to a result of the verification, modulation of a memory area to which the virtualization driver is allocated, of a memory area corresponding to a master boot record (MBR) of the guest OS, and of a memory area corresponding to a volume boot record (VBR) of the guest OS are blocked (S612). Here, the method for blocking modulation may be, for example, setting the authority to access the memory area to which the virtualization driver is allocated to “read only”.

In addition, in the guest OS, execution of the guest OS starts (S614), and execution of the virtualization driver starts (S616).

Prior to starting the execution of the guest OS and the execution of the virtualization driver at steps 614 and 616, comparison between the hash values may be performed as described with reference to FIG. 3 to determine whether to start the execution.

Thereafter, the security device identifies whether the guest OS and the virtualization driver are being executed (S618).

If the result of the identifying at step 618 is that the guest OS and the virtualization driver are being executed, the virtualization driver identifies whether access to the file occurs (S620).

If the result of the identifying at step 620 is that the access to the file occurred, the virtualization driver processes input/output of the file occurred according to the authority to access the file (S622).

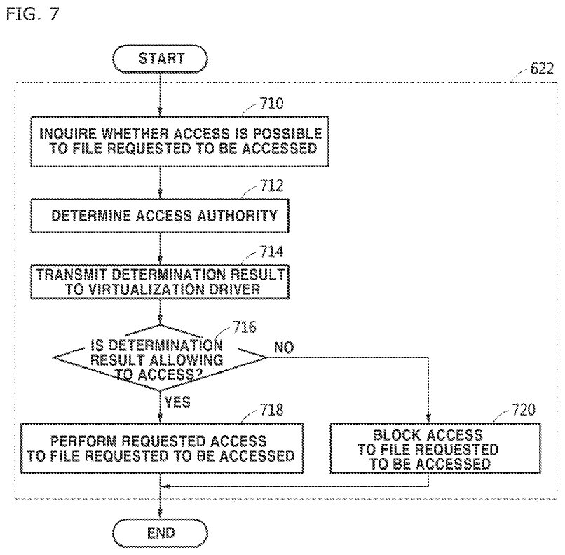

Step 622 for processing the access to the file will be described in detail hereinbelow with reference to FIG. 7.

FIG. 7 is a flowchart illustrating a process for processing an access to a file according to the authority to access the file in a security device according to an embodiment.

Referring to FIG. 7, the virtualization driver transmits access information of a file to the host OS file protector and inquires whether the access is possible (S710). Here, the access information of the file may include a full path name of the file, information of a process for accessing the file, and a requested accesstype (for example, read, write, execute, etc.).

The host OS file protector determines access authority regarding access to the file occurred through the protection policy manager (S712).

The host OS file protector transmits a result of determination regarding the access to the file occurred to the virtualization driver (S714).

The virtualization driver identifies whether the result of determination regarding the access to the file occurred is ‘allow the access’ (S716).

If the result of determination regarding the access to the file occurred at step 716 is allow the access, the virtualization driver processes such that the requested access to the file occurred may be performed (S718).

If the result of determination regarding the file according to the identifying at step 716 is ‘deny the access’, the virtualization driver processes such that the access to the file occurred is blocked (S720).

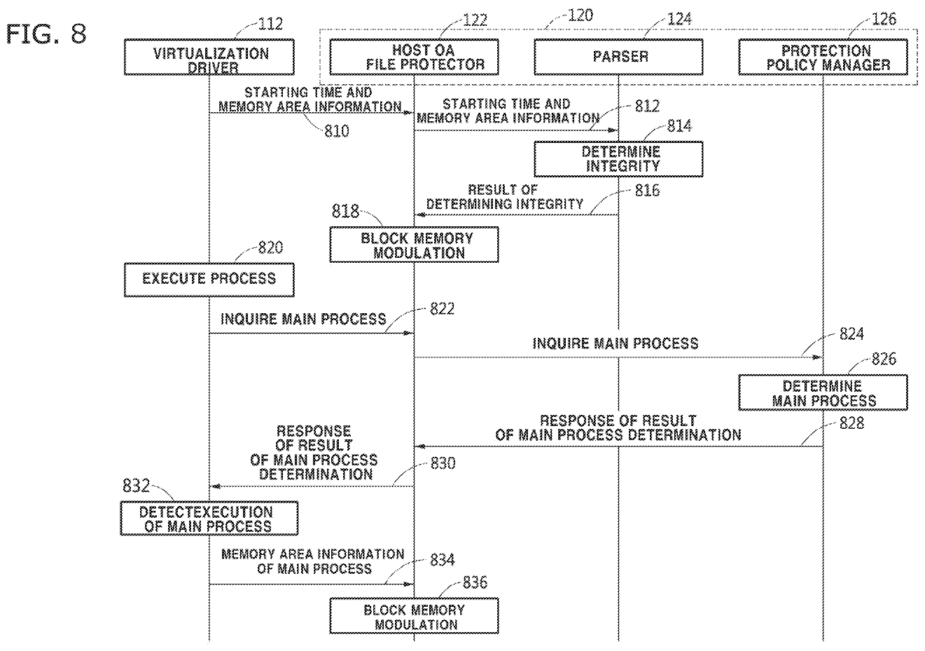

FIG. 8 is a view illustrating a message flow for protecting a file in a security device according to an embodiment.

Referring to FIG. 8, prior to starting in the guest OS, the virtualization driver 112 transmits the starting time and the memory area information of the virtualization driver to the host OS file protector 122 (S810).

The host OS file protector 122 provides the starting time and the memory area information of the virtualization driver to the parser 124 (S812).

Prior to starting the guest OS 110, the parser 124 parses the file system of the guest OS, and verifies integrity of the virtualization driver (S814).

In addition, the parser 124 provides the result of determination regarding integrity to the host OS file protector 122 (S816).

If the result of verification of the parser 124 is that the virtualization driver has integrity, the host OS file protector 122 blocks modulation by setting to “read only” so that writing is prohibited on the memory area to which the virtualization driver 112 is allocated, the memory area corresponding to the master boot record (MBR) of the guest OS and the memory area corresponding to the volume boot record (VBR) of the guest OS (S818).

Thereafter, if an access to a file occurs in the virtualization driver 112 (S820), the virtualization driver 112 transmits the access information of the file to which the access occurred to the host OS file protector 122 and inquires whether the access is possible (S822).

The host OS file protector 122 provides the access information of the file to which the access occurred to the protection policy manager 126, and inquires whether the access is possible (S824).

The protection policy manager 126 identifies the access authority regarding the access information of the file to which the access occurred from a list of files predetermined as subject for protection and determines whether the access is possible (S826), and transmits a result of determination to the host OS file protector 122 (S828).

If the result of determination regarding whether the access is possible regarding the access information of the file to which the access occurred is received from the protection policy manager 126, the host OS file protector 122 transmits the result of determination to the virtualization driver 112 (S830).

The virtualization driver 112 processes the access to the file to which the access occurred according to the result of determination regarding whether the access is possible regarding the file to which the access occurred (S832).

A method according to an embodiment may be implemented in the form of program instructions that may be performed through various computer means and may be recorded in a computer readable medium. The computer readable medium may include program instructions, data files, data structures and the like, solely or in combinations. The program instructions recorded in the medium may be those designed or configured specially for the embodiment or those that are well known and useable to those skilled in computer software. Examples of the computer readable medium include hard disks, floppy disks and magnetic media such as magnetic tape, optical media such as CD-ROM and DVD, magneto-optical media such as floptical disks, and hardware devices specially configured to store and perform program instructions such as ROMs, RAMs and flash memory etc. Examples of program instructions include not only machine language codes such as those created by a compiler, but also high-level language codes that may be executed by a computer using an interpreter. The hardware device may be configured to operate as one or more software modules in order to perform the operations of the embodiment, and vice versa.

Software may include computer programs, codes, instructions, or combinations of one or more thereof, and may configure a processing device to operate as desired, or independently or collectively instruct the processing device. Software and/or data may be embodied permanently or temporarily in any type of machine, component, physical device, virtual equipment, computer storage medium or device, or signal wave being transmitted. Software may be dispersed on a computer system connected by a network, and may be stored or implemented in a dispersed method. Software and data may be stored in one or more computer readable record medium.

Although the embodiments have been described by the limited drawings as described above, a person of ordinary skill in the art may apply various technical modifications and variations based on the above. For example, the described technologies may be performed in an order different from the described method, and/or a component such as a system, structure, device, circuit, and the like described may be combined in a form different from the described method, or even if alternated or substituted by other components or equivalents, an appropriate result may be achieved.

Therefore, other implementations, other embodiments, and equivalents to the claims also fall within the scope of the claims to be described hereinafter.

### REFERENCE NUMERALS

110: GUEST OPERATING SYSTEM
112: VIRTUALIZATION DRIVER
114: FILE SYSTEM
120: HOST OPERATING SYSTEM
122: HOST OPERATING SYSTEM FILE PROTECTOR
124: PARSER
126: PROTECTION POLICY MANAGER
128: HASH VALUE PARSER
130: LOCAL TERMINAL

What is claimed is:

1. A method for providing a security service in a security device, comprising:
detecting an execution request for an executable file of a guest OS or an executable file being executed in the guest OS;
if the execution request for the executable file is detected, searching a hash table fora hash value corresponding to the executable file;
if the hash value corresponding to the executable file is present in the hash table, calculating a hash value of the executable file;
comparing the found hash value and the calculated hash value; and
if the found hash value and the calculated hash value are the same as a result of the comparing, allowing to execute the executable file.

2. The method for providing a security service in a security device, according to claim 1,
further comprising:
prior to the detecting of the execution request for the executable file,
if requested to install the executable file, identifying whether the installation request is requested through a pre-allowed local network; and
if the installation request is requested through the pre-allowed local network according to a result of the identifying, calculating the hash value of the executable file using a predetermined hash function, and storing the calculated hash value in the hash table as the hash value corresponding to the executable file.

3. The method for providing a security service in a security device, according to claim 2,
further comprising:
if requested to update the executable file, identifying whether the update request is requested through a pre-allowed local network; and
if the update request is requested through the pre-allowed local network according to a result of the identifying, calculating a hash value of the updated executable file using the predetermined hash function, and storing the hash value of the updated executable file in the hash table as the hash value corresponding to the executable file.

4. The method for providing a security service in a security device, according to claim 1,
further comprising, if the hash value corresponding to the executable file is not present in the hash table or the found hash value and the calculated hash value are not the same according to a result of the comparing of the found hash value and the calculated hash value, preventing the executable file from being executed.

5. The method for providing a security service in a security device, according to claim 1,
wherein the hash table stores the hash value corresponding to a pre-installed executable file.

6. The method for providing a security service in a security device, according to claim 1,
wherein the hash table
stores the hash value corresponding to a pre-installed executable file, and
further includes at least one of identifier information for identifying the executable file or a path of the executable file.

7. A method for providing a security service in a security device, comprising:
parsing a file system of a guest operating system prior to starting the guest operating system and verifying integrity of a virtualization driver that executes the guest operating system;
if the virtualization driver has integrity according to a result of the verification, blocking modulation of a memory area to which the virtualization driver is allocated, a memory area corresponding to a master boot record (MBR) of the guest operating system, and a memory area corresponding to a volume boot record (VBR) of the guest operating system;
executing the guest operating system and the virtualization driver;
if an access to a file occurs in the virtualization driver, transmitting access information of the file to which the access occurred to a host operating system file protector and inquiring whether the access is possible;
determining authority to access the file through a protection policy manager in the host operating system file protector; and
transmitting a result of the determination regarding the access to the file to the virtualization driver.

8. The method for providing a security service in a security device, according to claim 7,
further comprising, if the result of the determination regarding the file received in the virtualization driver is deny the access, blocking the access to the file, and if the result of determination regarding the file received is allow the access, performing the requested access to the file.

9. The method for providing a security service in a security device, according to claim 7,
wherein the blocking of modulation of the memory area, if the host operating system file protector receives a starting time of the virtualization driver and an address of the memory area to be modulation-blocked from the virtualization driver, blocks modulation by setting the authority to access the memory area to which the virtualization driver is allocated, the memory area corresponding to the master boot record (MBR) of the guest operating system, and the memory area corresponding to the volume boot record (VBR) of the guest operating system to read only.

10. The method for providing a security service in a security device, according to claim 7,
wherein the determining of authority to access the file identifies and determines access authority of access information of the file from a list of files predetermined as subject for protection stored in the protection policy manager,
the access information of the file includes a path of the file, information of a process for accessing the file, and a requested access type, and
the list of files includes the path of the file and authority to access the file of an accessible process, or the path of the file and authority to access the file of a file modifying process.

11. The method for providing a security service in a security device, according to claim 7,
wherein the determining of authority to access the file identifies and determines access authority regarding access information of the file from a list of files predetermined as subject for protection stored in the protection policy manager,
the access information of the file includes an extension of the file, information of a process for accessing the file and a requested access type, and
the list of files includes information of an accessible process corresponding to each extension, authority to access a corresponding extension of the accessible process, or information of a file modifying process corresponding to each extension, authority to access the corresponding extension of the file modifying process.

12. A security device that provides a security service, comprising:
a hash value manager that, if a hash value corresponding to an executable file is present in a hash table, calculates a hash value of the executable file, and compares the hash value found from the hash table and the calculated hash value, and if the found hash value and the calculated hash value are the same, determines to allow executing the executable file; and
a host operating system file protector that, if an execution request for an executable file of a guest operating system or an executable file being executed in the guest operating system is detected, identifies whether the execution is possible through the hash value manager, and allows executing the executable file according to a result of determination.

13. The security device that provides a security service, according to claim 12,
wherein, if an installation request for the executable file is received prior to detecting the execution request for the executable file, the hash value manager identifies whether the installation request is requested through a pre-allowed local network by a predetermined local terminal, and if the installation request is requested through the pre-allowed local network by the predetermined local terminal, the hash value manager calculates the hash value of the executable file using a predetermined hash function, and stores the calculated hash value in the hash table as the hash value corresponding to the executable file.

14. The security device that provides a security service, according to claim 13,
wherein, if a update request for the executable file is received, the hash value manager identifies whether the update request is requested through a pre-allowed local network by the predetermined local terminal, and if the update request is requested through the pre-allowed local network by the predetermined local terminal, the hash value manager calculates a hash value of the updated executable file using the predetermined hash function, and stores the hash value of the updated executable file in the hash table as the hash value corresponding to the executable file.

15. The security device that provides a security service, according to claim 12,
wherein, if the hash value corresponding to the executable file is not present in the hash table, or the found hash value and the calculated hash value are not the same according to a result of comparing the found hash value and the calculated hash value, the hash value manager determines to not allow executing the executable file.

16. The security device that provides a security service, according to claim 12, further comprising:
a parser that parses a file system of the guest operating system prior to starting the guest operating system and verifies integrity of a virtualization driver for executing the guest operating system;
a protection policy manager that determines authority to access a file according to access information of the file; and
the virtualization driver that, if an access to the file occurs, transmits the access information of the file to which the access occurred to the host operating system file protector and inquires whether the access is possible,
wherein the host operating system file protector, if the virtualization driver has integrity according to a result of verification, blocks modulation of a memory area where the virtualization driver is allocated, a memory area corresponding to a master boot record (MBR) of the guest operating system, and a memory area corresponding to a volume boot record (VBR) of the guest operating system, and
if the access information of the file is received from the virtualization driver, transmits a result of determining the authority to access the file according to the access information of the file through the protection policy manager to the virtualization driver.

17. The security device that provides a security service, according to claim 16,
wherein, if the result of determination regarding the file received in the virtualization driver is deny the access, the virtualization driver blocks the access to the file, and if the result of determination is allow the access, the virtualization driver performs the access to the file.

18. The security device that provides a security service, according to claim 16,
wherein, if a starting time of the virtualization driver and an address of the memory area to be modulation-blocked are received from the virtualization driver, the host operating system file protector blocks the modulation by setting the authority to access the memory area to which the virtualization driver is allocated, the memory area corresponding to the master boot record (MBR) of the guest operating system, and the memory area corresponding to the volume boot record (VBR) of the guest operating system to read only.

19. The security device that provides a security service, according to claim 16,
wherein the protection policy manager identifies and determines the access authority regarding the access information of the file from a list of files predetermined as subject for protection stored in the protection policy manager,
the access information of the file includes a path of the file, information of a process for accessing the file, and a requested access type, and
the list of files includes the path of the file and authority to access the file of the accessible process, or the path of the file and authority to access the file of a file modifying process.

20. The security device that provides a security service, according to claim 16,
wherein the protection policy manager identifies and determines the access authority of the access information of the file from a list of files predetermined as subject for protection stored in the protection policy manager,
the access information of the file includes an extension of the file, information of a process for accessing the file, and a requested access type, and
the list of files includes information of the accessible process corresponding to each extension, authority to access the corresponding extension of the accessible process, or information of a file modifying process corresponding to each extension, authority to access the corresponding extension of the file modifying process.
